(19) United States
(12) Patent Application Publication
(10) Pub. No.: US 2012/0317377 A1
(43) Pub. Date: Dec. 13, 2012

(54) DUAL FLASH TRANSLATION LAYER

(76) Inventors: Alexander Palay, Kfar Saba (IL); Asif Sade, Maslul (IL)

(21) Appl. No.: 13/488,945

(22) Filed: Jun. 5, 2012

Related U.S. Application Data
(60) Provisional application No. 61/494,916, filed on Jun. 9, 2011.

(51) Int. Cl. G06F 12/00

(52) U.S. Cl. 711/154; 711/E12.001

(57) ABSTRACT

A method for operating a memory includes receiving memory access commands associated with respective target logical addresses, for execution in a memory. The target logical addresses are translated into respective intermediate logical addresses, in accordance with a first mapping having a first granularity of a first data unit size. The intermediate logical addresses are translated into respective physical storage locations in the memory, in accordance with a second mapping having a second granularity of a second data unit size, larger than the first data unit size. The memory access commands are executed in the memory in accordance with the respective physical storage locations.

### CROSS-REFERENCE TO RELATED APPLICATIONS

This application claims the benefit of U.S. Provisional Patent Application 61/494,916, filed Jun. 9, 2011, whose disclosure is incorporated herein by reference.

### FIELD OF THE INVENTION

The present invention relates generally to memory devices, and particularly to methods and systems for managing data in non-volatile memory devices.

### BACKGROUND OF THE INVENTION

Non-volatile memory, such as Flash memory, can be used in various applications and with various types of hosts. Data storage in Flash memory is typically organized and managed by a Flash management system, also referred to as Flash translation Layer (FTL).

### SUMMARY OF THE INVENTION

An embodiment of the present invention provides a method for operating a memory. The method includes receiving memory access commands associated with respective target logical addresses, for execution in a memory. The target logical addresses are translated into respective intermediate logical addresses, in accordance with a first mapping having a first granularity of a first data unit size. The intermediate logical addresses are translated into respective physical storage locations in the memory, in accordance with a second mapping having a second granularity of a second data unit size, larger than the first data unit size. The memory access commands are executed in the memory in accordance with the respective physical storage locations.

In some embodiments, the first data unit size includes a memory page. In other embodiments, the second data unit size includes a memory block. Yet in other embodiments, both translating the target logical addresses into the intermediate logical addresses and translating the intermediate logical addresses into the physical storage locations are performed in a single processor.

In some embodiments, translating the target logical addresses into the intermediate logical addresses is performed in a first processor, and translating the intermediate logical addresses into the physical storage locations is performed in a second processor that is separate from the first processor. In other embodiments, the second processor includes a memory controller, and the first processor includes a host processor.

In some embodiments, the method also includes receiving one or more parameters of the second mapping, and adapting the first mapping based on the received parameters. In other embodiments, the method also includes allocating in the second mapping storage space for storing management information for the first mapping. Yet in other embodiments, the method also includes instructing the second mapping by the first mapping to inhibit a function of the second mapping.

There is also provided, in accordance with an embodiment of the present invention, a data storage apparatus including a memory interface and at least one processor. The memory interface is configured to communicate with a memory. The at least one processor is configured to receive memory access commands associated with respective target logical addresses for execution in the memory, to translate the target logical addresses into respective intermediate logical addresses, in accordance with a first mapping having a granularity of a first data unit size, to translate the intermediate logical addresses into respective physical storage locations in the memory, in accordance with a second mapping having a second granularity of a second data unit size, larger than the first data unit size, and to execute the memory access commands in the memory in accordance with the respective physical storage locations.

There is also provided, in accordance with an embodiment of the present invention, a method for operating a memory, including receiving memory access commands for execution in the memory. The received memory access commands are processed using a first memory management layer having a first granularity of a first data unit size, so as to produce a first output. The first output is processed using a second memory management layer, having a second granularity of a second data unit size that is larger than the first data unit size, so as to produce a second output. The memory access commands are executed in the memory in accordance with the second output.

There is also provided, in accordance with an embodiment of the present invention, a data storage apparatus including a memory interface and at least one processor. The memory interface is configured to communicate with a memory. The at least one processor is configured to receive memory access commands for execution in the memory, to process the received memory access commands using a first memory management layer having a first granularity of a first data unit size, so as to produce a first output, to process the first output using a second memory management layer, having a second granularity of a second data unit size that is larger than the first data unit size, so as to produce a second output, and to execute the memory access commands in the memory in accordance with the second output.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a memory system that uses a dual-hierarchy Flash translation Layer (FTL), in accordance with an embodiment of the present invention; and

FIG. 2 is a flow chart that schematically illustrates a method for memory management, in accordance with an embodiment of the present invention.

### DETAILED DESCRIPTION OF EMBODIMENTS

### Overview

A typical Flash memory is divided into multiple memory blocks, each block comprising multiple memory pages. Data is written and read in page units, but erased in block units (also referred to as physical blocks or erasure blocks). Moreover, data cannot be overwritten in-place, i.e., a new page cannot be overwritten over an old page in the same physical location unless the entire block is erased first. As a result of these characteristics, data storage in Flash memory typically involves complex management functions referred to collectively as Flash management or Flash Translation Layer (FTL).

Embodiments of the present invention provide improved systems and methods for managing data storage in non-volatile memory, such as Flash memory, by separating the FTL into two hierarchical memory management layers, an upper FTL and a lower FTL. The lower FTL, which stores and retrieves data directly in the Flash device or devices, operates at a certain granularity or data unit size (e.g., at block level). The upper FTL, which mediates between the lower FTL and a host, operates at a finer granularity or data unit size (e.g., at page level). The two FTLs interact with one another so as to improve performance.

When using this sort of dual-hierarchy FTL, low-end Flash-based memory systems can be integrated and used in high-end memory systems, such as Solid State Drives (SSD) or enterprise storage systems, in a straightforward manner. For example, the upper FTL can be implemented in software that runs in the host, thus eliminating the need for a dedicated high-end controller, or for redesigning the entire FTL. Moreover, the dual FTL configuration enables reusing the same lower FTL in various types of memory systems, both high-end and low-end.

### System Description

Data storage in Flash memory typically involves management functions including, for example, logical-physical address mapping, block compaction (“garbage collection”), and block wear leveling. Since data cannot be overwritten in the Flash without first erasing the entire block, rewriting new data at a certain logical address results in the data being stored at a new physical location in the Flash, followed by an appropriate update of the logical-physical address mapping.

After a number of programming and erasure cycles, the Flash memory blocks develop regions of invalid data. Block compaction, or garbage collection, is the process of copying valid data from fragmented blocks into fresh blocks (i.e., previously erased blocks). Garbage collection also involves remapping of the logical to physical addresses to account for the new physical locations where the compacted data is stored.

Dynamic wear leveling is a process where the FTL selects and compacts blocks that have accumulated large amounts of invalid data. Static wear leveling is a process that compacts blocks not frequently updated to different blocks, for the purpose of balancing the wear on the memory blocks.

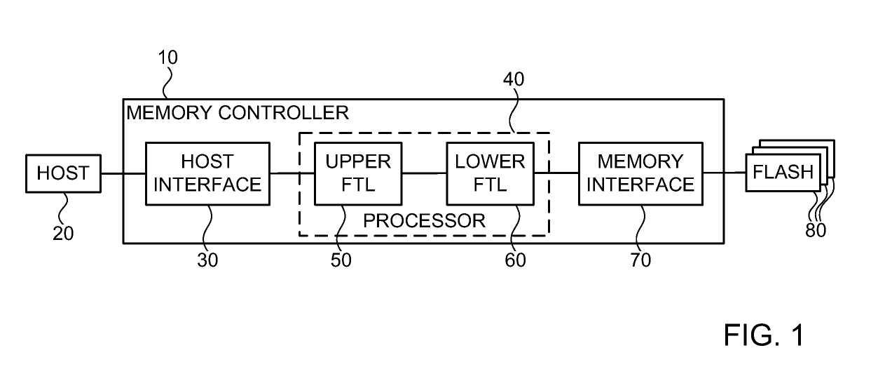

Management functions of this sort, including logical-to-physical address mapping, block compaction and wear leveling, are referred to collectively as Flash management of Flash Translation Layer (FTL). FIG. 1 is a block diagram that schematically illustrates a memory system that uses a dual-hierarchy FTL, in accordance with an embodiment of the present invention. The system comprises a memory controller 10 that interfaces with a host system 20. Host system 20 may comprise, for example, an enterprise storage system, a computing device such as a notebook or laptop computer, or any other suitable host system.

Memory controller 10 comprises a host interface 30, which accepts memory access commands from the host and relays them to a processor 40. Processor 40 is split into an upper FTL 50 and a lower FTL 60, both of which may comprise physical circuitry, or software executed by the processor, in accordance with the embodiments of the present invention. In some embodiments, the functions of upper FTL 50 are carried out by host system 20.

Processor 40 executes the memory access commands through a memory interface 70 in one or more non-volatile memory devices, in the present example Flash memory devices 80. Typically, each memory device 80 may comprise one or more Flash dies, each die may comprise one or more memory planes, and each plane comprises a large number of memory blocks. Each block comprises multiple rows of Flash memory cells. A given row of memory cells may store one or more memory pages.

Some or all of the functions of memory controller 10 may be implemented in hardware. Alternatively, memory controller 10 may comprise a microprocessor that runs suitable software, or a combination of hardware and software elements. In some embodiments, memory controller 10 comprises a general-purpose processor, which is programmed in software to carry out the functions described herein. The software may be downloaded to the processor in electronic form, over a network, for example, or it may, alternatively or additionally, be provided and/or stored on non-transitory tangible media, such as magnetic, optical, or electronic memory.

The block diagram in FIG. 1 is shown only for conceptual clarity and not by limitation of the embodiments of the present invention. In alternative embodiments, any other suitable memory system configuration can also be used. Elements that are not necessary for understanding the principles of the present invention have been omitted from the figure for clarity.

In the example system configuration shown in FIG. 1, memory devices 80 and memory controller 10 are implemented as two separate Integrated Circuits (ICs). In alternative embodiments, however, the memory devices and the memory controller may be integrated on separate semiconductor dies in a single Multi-Chip Package (MCP) or System on Chip (SoC), and may be interconnected by an internal bus. Further alternatively, some or all of the memory controller circuitry may reside on the same die on which one or more of the memory devices are disposed. Further alternatively, some or all of the functionality of memory controller 10 can be implemented in software and carried out by a suitable processor in host system 20. In some embodiments, the processor of host system 20 and memory controller 10 may be fabricated on the same die, or on separate dies in the same device package.

### Dual-FTL Configuration

Memory controller 10 stores data in Flash memory devices 80 on behalf of host 20 using upper FTL 50 and lower FTL 60. Typically, the memory controller receives the memory access commands from host 20 with respective target logical addresses in which the data is to be written or read.

Each of the two FTLs maps data with a certain granularity, i.e., using data units of a certain size. The data unit sizes are set such that the upper FTL maps data with a finer granularity (i.e., using a smaller data unit size) than the lower FTL.

In an example embodiment, the lower FTL is configured to use block mapping, or a mapping with a large granularity of a data unit size typically on the order of 10⁶ memory cells. The upper FTL in this embodiment is a more complex system that is configured to map data with memory page granularity, i.e., page mapping. This mapping comprises a smaller granularity of data unit size typically on the order of 10³-10⁴ memory cells. Alternatively, however, the upper and lower FTLs may use any other suitable granularities, i.e., data unit sizes.

In some embodiments, executing memory access commands using the two FTLs involves a two-stage address mapping process: Upper FTL 50 translates the target logical addresses provided in the commands into respective intermediate logical addresses, and lower FTL 60 translates the intermediate logical addresses into physical storage locations in memory devices 80. The first mapping is referred to herein as Logical-Logical (L-L) mapping, and the second mapping is referred to herein as Logical-Physical (L-P) mapping.

In some embodiments, lower FTL 60 reports one or more of its management parameters to upper FTL 50. The management parameters may comprise, for example, the number of NAND dies, the number of planes, the block size, the page size, the data unit size (mapping unit size) used by the lower FTL, the number of available blocks in the lower FTL, the number of bad (non-functional) blocks, and/or any other suitable management parameter.

The upper FTL is configured to utilize the parameters received from the lower FTL hierarchy to optimize management for performance and Flash endurance. For example, the parameters may comprise the size of information that can be programmed in parallel to achieve programming performance optimization (e.g., parallel programming of dies or planes). The parameters may also provide information about dependency between different pages, e.g., for handling NAND page corruption in the event of a sudden power failure.

In some embodiments, lower FTL 60 allocates memory space (in memory devices 80 or in Random Access Memory—RAM) for storing metadata and management data of upper FTL 50. The lower FTL may provide to the upper FTL a dedicated Application Programming Interface (API) or dedicated partitions and/or addresses to store this information. In other embodiments, these dedicated storage areas in the lower FTL may be specified to provide a certain performance level, e.g., read/write speed, latency, endurance or reliability.

In some embodiments, the upper FTL may instruct the lower FTL to inhibit certain functions of the lower FTL, in order to optimize performance, endurance, reliability or other performance measure. For example, the upper FTL may disable the static wear leveling process carried out by the lower FTL. Additionally or alternatively, the upper FTL may inhibit any other function of the lower FTL. The upper FTL may inhibit a given function of the lower FTL for a limited time, for limited endurance (e.g., for a specified number of programming and erasure cycles) or permanently.

In the embodiments of the present invention, garbage collection is typically performed in the upper FTL since garbage collection utilizes a large amount of page mapping resources. Wear leveling processes typically operate at block level and are thus typically handled by the lower FTL. In some embodiments, the upper and lower FTLs synchronize these processes with one another.

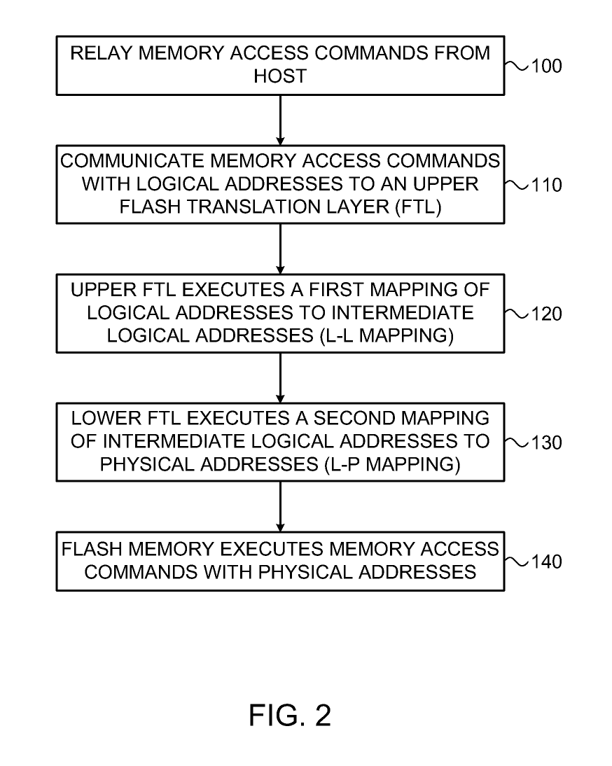

FIG. 2 is a flow chart that schematically illustrates a method for memory management, in accordance with an embodiment of the present invention. At a command relaying step 100, host 20 provides memory access commands to memory controller 10. At a communication step 110, the memory access commands comprising respective target logical addresses are communicated to upper Flash Translation Layer (FTL) 50.

At a first mapping step 120, upper FTL 50 executes a first mapping of the target logical addresses to intermediate logical addresses (L-L mapping). At a second mapping step 130, lower FTL 60 executes a second mapping of the intermediate logical addresses to physical addresses (L-P mapping) comprising the physical storage locations in memory devices 80. In the present example the first mapping is performed at page granularity and the first mapping is performed at block granularity. At an execution step 140, lower FTL 40 executes the memory access commands in the respective physical addresses.

Although the embodiments described herein mainly address Flash management, the methods and systems described herein can also be used in other applications comprising two stages of processing operations where the first stage has a large amount of memory resources, such as random access memory (RAM), to manage operations, and the second stage comprises limited resources and is more associated with the physical media.

It will thus be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A method for operating a memory, comprising:
receiving memory access commands associated with respective target logical addresses, for execution in a memory;
translating the target logical addresses into respective intermediate logical addresses, in accordance with a first mapping having a first granularity of a first data unit size;
translating the intermediate logical addresses into respective physical storage locations in the memory, in accordance with a second mapping having a second granularity of a second data unit size, larger than the first data unit size; and
executing the memory access commands in the memory in accordance with the respective physical storage locations.

2. The method according to claim 1, wherein the first data unit size comprises a memory page.

3. The method according to claim 1, wherein the second data unit size comprises a memory block.

4. The method according to claim 1, wherein both translating the target logical addresses into the intermediate logical addresses and translating the intermediate logical addresses into the physical storage locations are performed in a single processor.

5. The method according to claim 1, wherein translating the target logical addresses into the intermediate logical addresses is performed in a first processor, and wherein translating the intermediate logical addresses into the physical storage locations is performed in a second processor that is separate from the first processor.

6. The method according to claim 5, wherein the second processor comprises a memory controller, and wherein the first processor comprises a host processor.

7. The method according to claim 1, and comprising receiving one or more parameters of the second mapping, and adapting the first mapping based on the received parameters.

8. The method according to claim 1, and comprising allocating in the second mapping storage space for storing management information for the first mapping.

9. The method according to claim 1, and comprising instructing the second mapping by the first mapping to inhibit a function of the second mapping.

10. A data storage apparatus, comprising:
a memory interface, which is configured to communicate with a memory; and
at least one processor, which is configured to receive memory access commands associated with respective target logical addresses for execution in the memory, to translate the target logical addresses into respective intermediate logical addresses, in accordance with a first mapping having a granularity of a first data unit size, to translate the intermediate logical addresses into respective physical storage locations in the memory, in accordance with a second mapping having a second granularity of a second data unit size, larger than the first data unit size, and to execute the memory access commands in the memory in accordance with the respective physical storage locations.

11. The apparatus according to claim 10, wherein the first data unit size comprises a memory page.

12. The apparatus according to claim 10, wherein the second data unit size comprises a memory block.

13. The apparatus according to claim 10, wherein the at least one processor comprises a single processor that is configured to translate the target logical addresses into the intermediate logical addresses and to translate the intermediate logical addresses into the physical storage locations.

14. The apparatus according to claim 10, wherein the at least one processor comprises a first processor that is configured to translate the target logical addresses into the intermediate logical addresses, and a second processor that is separate from the first processor and is configured to translate the intermediate logical addresses into the physical storage locations.

15. The apparatus according to claim 14, wherein the second processor comprises a memory controller, and wherein the first processor comprises a host processor.

16. The apparatus according to claim 10, wherein the at least one processor is configured to receive one or more parameters of the second mapping, and to adapt the first mapping based on the received parameters.

17. The apparatus according to claim 10, wherein the at least one processor is configured to allocate in the second mapping storage space for storing management information for the first mapping.

18. The apparatus according to claim 10, wherein the at least one processor is configured to instruct the second mapping by the first mapping to inhibit a function of the second mapping.

19. A method for operating a memory, comprising:
receiving memory access commands for execution in the memory;
processing the received memory access commands using a first memory management layer having a first granularity of a first data unit size, so as to produce a first output;
processing the first output using a second memory management layer, having a second granularity of a second data unit size that is larger than the first data unit size, so as to produce a second output; and
executing the memory access commands in the memory in accordance with the second output.

20. A data storage apparatus, comprising:
a memory interface, which is configured to communicate with a memory; and
at least one processor, which is configured to receive memory access commands for execution in the memory, to process the received memory access commands using a first memory management layer having a first granularity of a first data unit size, so as to produce a first output, to process the first output using a second memory management layer, having a second granularity of a second data unit size that is larger than the first data unit size, so as to produce a second output, and to execute the memory access commands in the memory in accordance with the second output.
